(19) United States
(12) Patent Application Publication
(10) Pub. No.: US 2025/0352430 A1
(43) Pub. Date: Nov. 20, 2025

(54) SYSTEMS AND METHODS FOR RADIALLY COMPRESSIBLE BLOW-FILL-SEAL (BFS) DEVICES

(71) Applicant: Koska Family Limited, East Sussex (GB)

(72) Inventors: Jeff Price, Windermere, FL (US); Margaret Marie Reiff, Cary, NC (US); Lindsay Marie Pierle, Durham, NC (US)

(21) Appl. No.: 19/289,365

(22) Filed: Aug. 4, 2025

Related U.S. Application Data
(63) Continuation of application No. PCT/US2024/014394, filed on Feb. 5, 2024.
(60) Provisional application No. 63/483,290, filed on Feb. 5, 2023.

(51) Int. Cl. A61J 1/06

(52) U.S. Cl. CPC A61J 1/067; A61J 2205/50

(57) ABSTRACT

Systems and methods for Blow-Fill-Seal (BFS) vials configured to expel a desired quantity of medicament in response to a designed range of radially inward squeeze-force applications received via a compressible fluid reservoir.

### CROSS-REFERENCE TO RELATED APPLICATIONS

This application claims benefit and priority under 35 U.S.C. § 120 to, and is a Continuation of, International Patent Application No. PCT/US24/14394 filed on Feb. 5, 2024 and titled “SYSTEMS AND METHODS FOR RADIALLY COMPRESSIBLE BLOW-FILL-SEAL (BFS) DEVICES”, which itself claims benefit and priority to U.S. Provisional Patent Application No. 63/483,290 filed on Feb. 5, 2023 and titled “SYSTEMS AND METHODS FOR RADIALLY COMPRESSIBLE BLOW-FILL-SEAL (BFS) DEVICES”, each of which is hereby incorporated by reference herein in the entirety.

### BACKGROUND

Staggering numbers of people become infected, severely ill and/or die from a variety of diseases each year, some of which are preventable (or the severity of which could have been mitigated) through injectable medicines, medicaments, vaccines, drug products or other fluid agents (collectively “injectable medicines” herein, injectable medicines referring to fluid agents delivered via use of a syringe or other needle-type medical delivery device). Although injectable medicines have led to a decline in the number of cases of several infectious diseases (or the severity of symptoms or instances of death resulting therefrom) and/or ability to better manage ongoing health conditions such as diabetes, and have also become useful for administration of other medicaments such as contraceptives, the need for additional innovation in injectable medicines remains because the demand for effective contraceptive programs and control of existing and emerging diseases continues to grow and existing solutions leave room for further improvements. Applicant has previously invented various methods and systems intended to address the growing demand for injectable medicines through single-dose, pre-filled Blow-Fill-Seal (BFS) injector devices that comprise one or more benefits, such as (i) being manufacturable in a cost effective manner, in large quantities and at short notice to meet unanticipated peaks in demand; (ii) incorporating simplicity of design that lends itself to administration by users who have little or no medical training (e.g., are suitable for self-injection); and/or (iii) including features that minimize risk of re-use or otherwise prioritize safety concerns. Applicant continues to innovate in this field by developing various new and beneficial systems, devices and components that will provide additional options and opportunities for drug manufacturers to select a single-dose, pre-filled delivery system that best fits their needs.

### SUMMARY

Plastic fluid containers manufactured via the Blow-Fill-Seal (BFS) process have been utilized for various purposes. BFS is an automated manufacturing and filling process in which plastic containers are formed, filled and sealed in a continuous operation. BFS bottles have been utilized over the past several decades to house, for example, (i) medicament that is drawn from the bottle, one dose at a time via a syringe, for administration to a patient via the syringe, e.g., (ii) ophthalmic and nasal products; (iii) nebulizer solutions and other inhalant medications; and (iv) medicament storage within auto-injectors in which a spring and associated mechanical components form a linear actuating or axial compression mechanism (all the foregoing in single-dose and multi-dose sizes). Other than the designed carrying volume and the general need for structural integrity (e.g., no leakage) of the bottles, the use cases for BFS bottles have often resulted in few design constraints, allowing for large-scale manufacturing of various BFS vial designs that are not particularly dependent on precise design specifications or sensitive to which of various available manufacturing practices are employed. While many of these known designs comprise a compressible portion such as a fluid reservoir (compressible due to the “soft” plastic utilized in the BFS process), due to the applications or use cases previously utilized for BFS vials, there has been no need to precisely engineer the compressibility of the BFS bottle.

Applicant, however, has recognized and developed the applicability of BFS vials for a new type of use case: as a component of human-pinch-squeezable injector device for injecting a single dose of a fluid agent (e.g., a pharmaceutical drug product such as a vaccine or birth control treatment) directly from the BFS container and into a patient (without the need of an intermediary step of drawing the fluid agent out of the vial via a syringe), by mating the BFS vial to an administrative member comprising a needle, such as through a proprietary needle hub. Such BFS injectables provide for the single-dose of the fluid agent within the BFS vial to be squeezed (via a pinch-type squeeze action or radial compression) through the needle/administration member that is mated to the BFS vial, directly into the patient. In developing its novel BFS injector devices, however, Applicant has identified a need for BFS vial designs and manufacturing criteria that help ensure a sufficient portion of the fluid agent (e.g., ninety percent (90%); or other dose delivery requirements that may depend on the particular fluid agent housed in the BFS vial) is extracted as a result of a single radial compression action (a single pinch-type squeeze by a user). In other words, Applicant has identified that specific levels or ranges of compressibility (such that the single dose of a stored fluid agent can be sufficiently extracted from the vial, through a needle, directly into a patient and via a radial compression action of a human) can be important performance criteria for the BFS vials utilized as components of a single-dose BFS injector. Thus, Applicant has developed, through much experimentation, design and manufacturing specifications that provide for a BFS vial that satisfies such performance criteria.

In prior use cases of some BFS bottles, the BFS bottles are employed to be squeezed to expel the contents thereof (e.g., for ophthalmic drops or nebulizer fluids such as Albuterol), but such uses do not involve the extraction of all (or most) of the contents during a single administration event driven by a human exerting a radial compression on the container to squeeze all or most of the contents out of the container through a needle and into a patient, and thus the level of compressibility has not been of concern when designing or manufacturing such vials.

With the advent of viable single-use, single-dose, pre-filled and/or disposable BFS medical injection devices such as those described in Applicant's co-pending U.S. patent application Ser. No. 17/960,111 titled SYSTEMS AND METHODS FOR PRE-FILLED MEDICAL DELIVERY DEVICES and filed on Oct. 4, 2022, however, compressibility has been discovered to be a factor that may be important to the overall design. Such injection devices may provide many benefits (e.g., in relation to previous injection solutions). However, because they introduce a new operational paradigm that does not require a separate syringe or vacuum force for extraction of fluid, factors relating to the compressibility of the fluid reservoir may not be adequately satisfied with previous BFS bottle designs.

According to some embodiments, the squeeze-force required to compress (e.g., achieve structural deformation between fifty percent (50%) and one hundred percent (100%)) a reservoir of a BFS vial via radially inward compressive force (e.g., human squeeze or pinch force) may be specifically configured to be between thirty Newtons (30-N) and forty Newtons (40-N) by configuring: (i) a length of the BFS vial and/or of the reservoir thereof, (ii) a fill-orientation of the BFS vial/reservoir, (iii) a wall thickness of the BFS vial reservoir, (iv) a cross-sectional geometric configuration of the BFS vial reservoir, and/or (v) a liquid-to-air ratio of fluid filled within the BFS vial reservoir. In some embodiments, the BFS vial reservoir may be formed with a low-arch cross-sectional geometry and filled in an up-right position such that the reservoir is not axially coincident with a mold seam. In some embodiments, such as in an up-right filling configuration a mold seam may be utilized to facilitate alignment, indexing, and/or coupling or mating of an administration member to a BFS vial. In some embodiments, any two (2) or more of the above-listed parameters/factors may be cooperatively configured to set the desired/target squeeze force. According to some embodiments, a mold seam disposed on a side flange or “wing” of the BFS vial may be utilized to couple and/or mater with the administration member (e.g., the administration member comprising at least one feature such as an interior groove, detent, and/or aperture sized and shaped to receive and/or latch onto at least one of the mold seams of the side flanges of the BFS vial).

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1A, FIG. 1B, FIG. 1C, FIG. 1D, FIG. 1E, and FIG. 1F are various views of a BFS vial system according to some embodiments;

FIG. 2A, FIG. 2B, FIG. 2C, FIG. 2D, FIG. 2E, FIG. 2F, FIG. 2G, and FIG. 2H are various views of a BFS vial system according to some embodiments;

FIG. 3 is a BFS vial system with side views showing design differences between two (2) different BFS vials; and

FIG. 4A and FIG. 4B are graphs showing example test results for BFS vial designs.

### DETAILED DESCRIPTION

### I. Introduction

Embodiments described herein provide systems and methods for radially compressible Blow-Fill-Seal (BFS) vials or bottles such as may be utilized in (or for) pre-filled medical delivery devices and/or assemblies, that overcome drawbacks of previous delivery devices and methods. For example, the BFS vials may be specially configured to be compressible in response to a designed squeeze-force level that is likely to result in adequate dosage effluent from the BFS vial. In some embodiments, such a BFS vial may be constructed with specific geometries and/or dimensions that enable the proper dosage to be expelled in response to a designed squeeze-force level. In some embodiments, the fill orientation of molded vials may be specifically selected and/or utilized to enable advantageous vial geometries that facilitate realization of a desired squeeze-force value and/or range. According to some, a mold line formed at a junction between a main mold and a head or sealing mold, on a BFS vial, may be utilized to facilitate coupling, engagement, alignment, indexing, and/or retaining of an administration member to/with the BFS vial.

### II. Radially Compressible BFS Vials

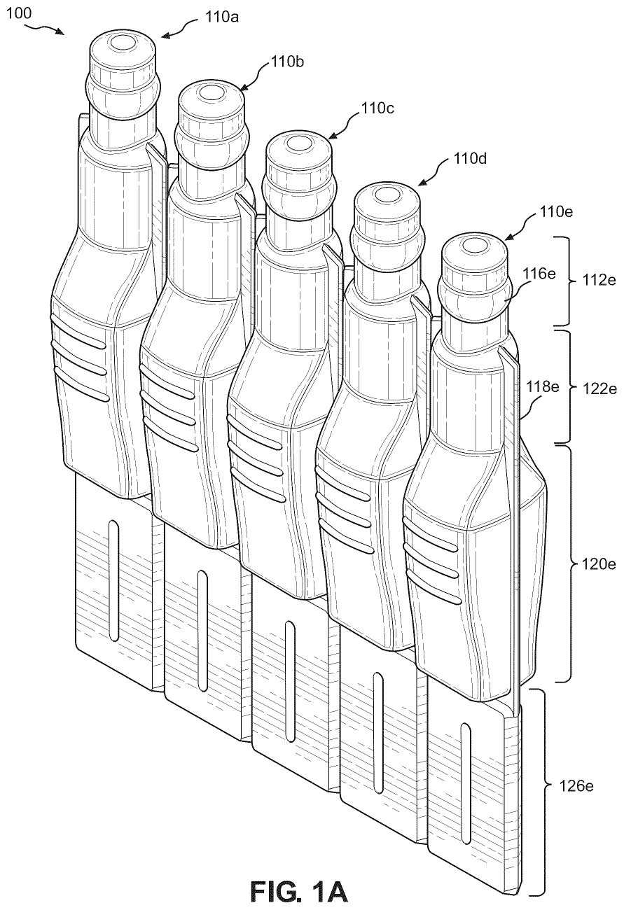

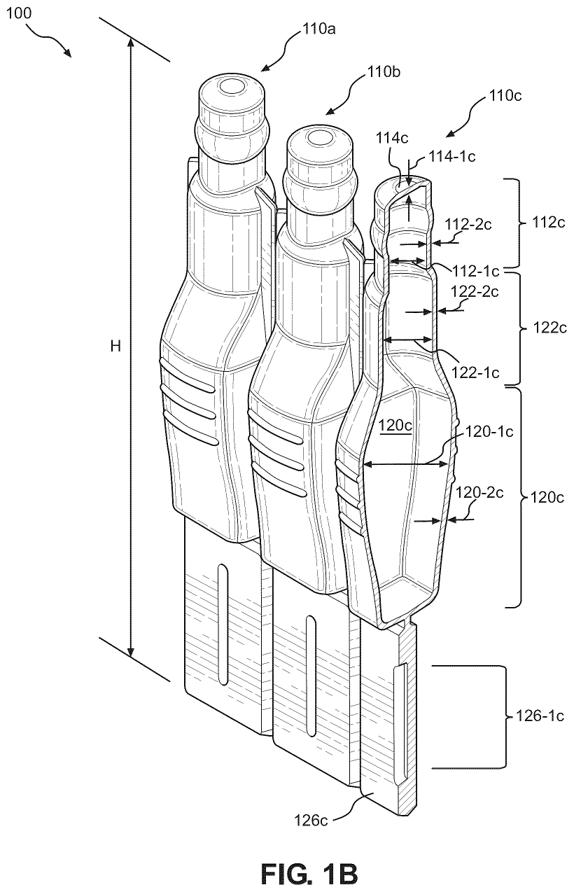

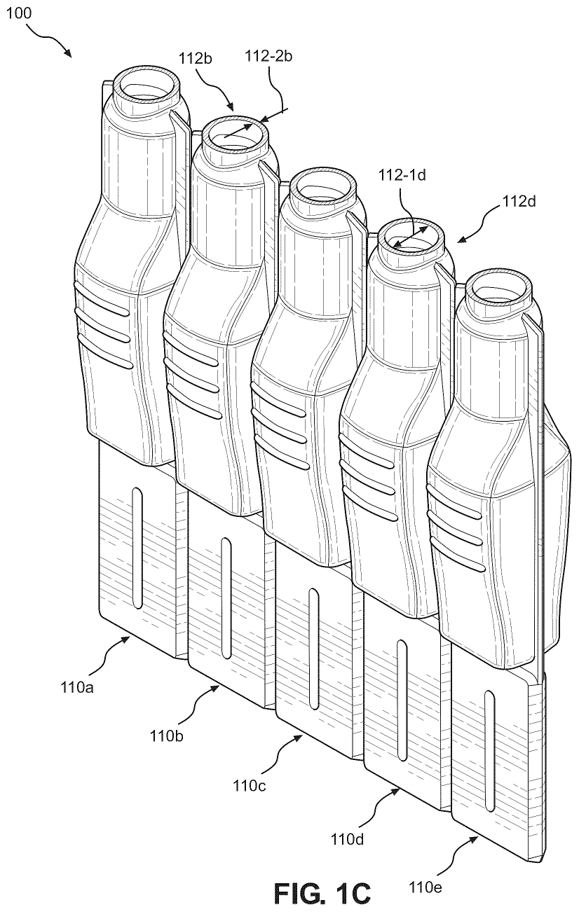

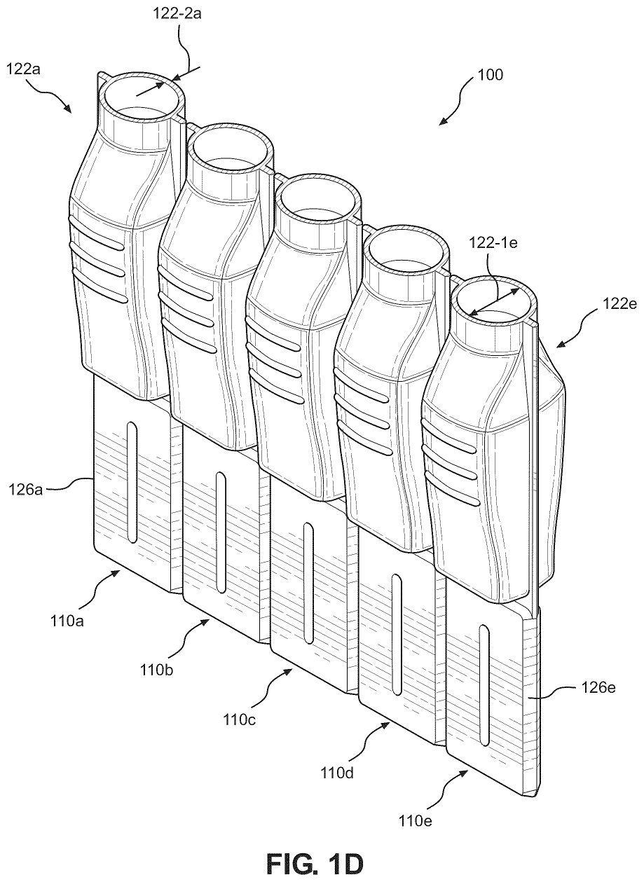

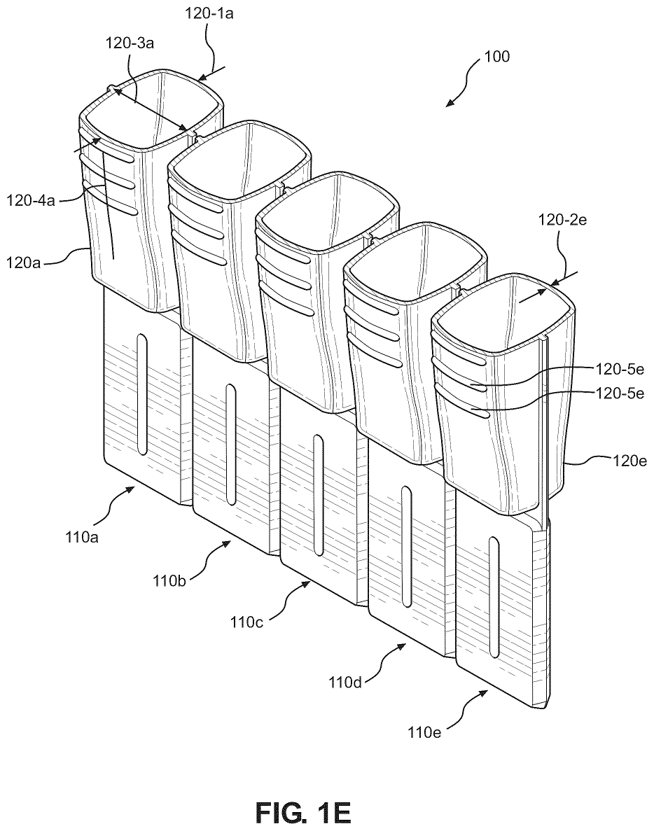

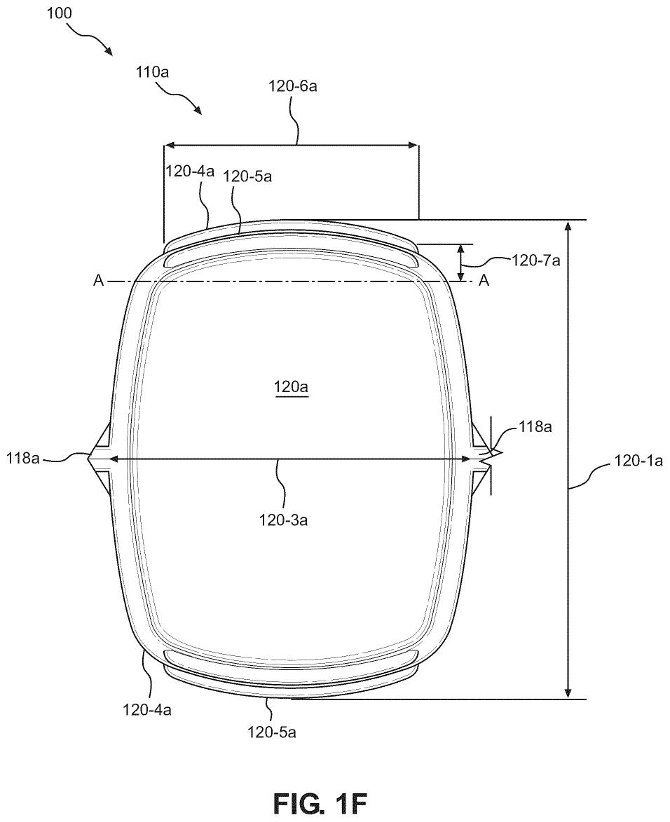

Referring to FIG. 1A, FIG. 1B, FIG. 1C, FIG. 1D, FIG. 1E, and FIG. 1F, various views of a BFS vial system 100 (or a portion thereof) according to some embodiments are shown. The BFS vial system 100 may comprise, for example, a plurality of BFS bottles, containers, and/or vials 110a-e manufactured via a BFS process in which a fluid (not separately depicted) is injected into the BFS vials 110a-e during the manufacturing process (e.g., in a sterile environment). While five (5) BFS vials 110a-e are shown for purposes of non-limiting example and ease of illustration, fewer or more BFS vials 110a-e may be included in the system 100 in some embodiments. In some embodiments, for example, the system 100 may comprise a set or “card” of BFS vials 110a-e that are formed as an interconnected grouping/object during the BFS manufacturing process and such a “card” may comprise and/or define twenty-five (25) BFS vials 110a-e (and a corresponding mold, not shown, may comprise twenty-five (25) corresponding mold cavities). According to some embodiments, the BFS vials 110a-e may comprise and/or define various geometric and/or design attributes configured to enable a design squeeze-force, as described herein. With exemplary reference to a perspective view of the BFS vial system 100 depicting features of a fifth BFS vial 110e shown in FIG. 1A, for example, the fifth BFS vial 110e may comprise and/or define a neck portion 112e that terminates at a fifth fluid seal 114e disposed at a first end of the fifth BFS vial 110e. In some embodiments, the neck portion 112e may comprise and/or define a mounting collar 116e formed as an axially elongated and/or rounded exterior flange or projection, e.g., the example “doughnut” shaped mounting collar 116e as depicted. According to some embodiments, the fifth BFS vial 110e may comprise and/or define a side flange 118e which may, for example, comprise “unmolded” portions of fused parison (e.g., eighty-four hundredths of a millimeter (0.84-mm) with a variation of plus or minus five hundredths of a millimeter (+−0.05-mm) in thickness), e.g., that connect the various BFS vials 110a-e. In some embodiments, the fifth BFS vial 110e may comprise and/or define a fifth fluid reservoir 120e and/or a fifth chamber portion 122e in fluid communication therewith. In some embodiments, the fifth BFS vial 110e may comprise a fifth label tab 126e, e.g., formed and/or disposed at a second end of the fifth BFS vial 110e.

In some embodiments, and with exemplary reference to a perspective axial cross-section of a third BFS vial 110c shown in FIG. 1B, the third BFS vial 110c may comprise and/or define a third neck portion 112c, a third fluid seal 114c, a third fluid reservoir 120c, a third chamber portion 122c, and/or a third label tab 126c. According to some embodiments, the third neck portion 112c may comprise and/or define a third neck diameter 112-1c and/or a third neck wall thickness 112-2c, and/or the third fluid seal 114c may comprise and/or define a third fluid seal wall thickness 114-1c. According to some embodiments, the third fluid seal wall thickness 114-1c may be between four tenths of a millimeter (0.4-mm) and nine tenths of a millimeter (0.9-mm). The third fluid seal wall thickness 114-1c may, for example, be configured to facilitate piercing of the third fluid seal 114c. In some embodiments, the third fluid seal wall thickness 114-1c may be configured to be sixty-five hundredths of a millimeter (0.65-mm) with a variation of plus or minus twenty-five hundredths of a millimeter (+−0.25-mm).

In some embodiments, the third fluid reservoir 120c may comprise and/or define a third reservoir diameter 120-1c and/or a third reservoir wall thickness 120-2c. According to some embodiments, the third chamber portion 122c may comprise and/or define a third chamber diameter 122-1c and/or a third chamber wall thickness 122-2c. In some embodiments, the various diameters 112-1c, 120-1c, 122-1c and/or wall thicknesses 112-2c, 120-2c, 122-2c may be configured, designed, and/or manufactured to specialized specifications that, e.g., enable the BFS vials 110a-e to be reliably and effectively utilized to deliver an accurate dose of medicament. The third reservoir diameter 120-1c may be configured to be twelve and sixty-three hundredths millimeters (12.63-mm) with a variation of plus or minus five one and five hundredths of a millimeter (+−1.05-mm), for example, and/or the third chamber diameter 122-1c may be configured to be seven and eighty-five hundredths millimeters (7.85-mm) with a variation of plus or minus two tenths of a millimeter (+−0.20-mm). In some embodiments, any or all of the wall thicknesses 112-2c, 120-2c, 122-2c may be configured to be fifty-five hundredths of a millimeter (0.55-mm) with a variation of plus or minus fifteen hundredths of a millimeter (+−0.15-mm).

According to some embodiments, the BFS vials 110a-e and/or the BFS vial system 100 may comprise and/or define an overall height (“H”) that extends from the first end to the second end of each BFS vial 110a-e. In some embodiments, the height “H” may be lengthened with respect to previous designs. The height “H” may be set to be between seventy-three millimeters (73-mm) and seventy-nine millimeters (79-mm), for example, such that a set amount of plastic resin available for molding (e.g., across the vertical height of a given mold body; not shown) is distributed over a larger area, resulting in thinner wall thicknesses (e.g., overall or in specific areas of the BFS vials 110a-e). According to some embodiments, the height “H” may be configured to be seventy-six millimeters (76-mm).

In some embodiments, the third label tab 126c may comprise and/or define a third rib or detent feature 126-1c that may, for example, cause the third label tab 126c to be more rigid and/or reduce the likelihood of the third label tab 126c becoming warped during or after the manufacturing process. The third detent feature 126-1c may be formed as an axial detent, as depicted for example, that provides structural bracing along the axis of the third label tab 126c.

According to some embodiments, and with exemplary reference to a perspective radial cross-section of the BFS vial system 100 shown in FIG. 1C, a fourth BFS vial 110d may comprise and/or define a fourth neck diameter 112-1d and/or a second BFS vial 110b may comprise and/or define a second neck wall thickness 112-2b, each at a respective neck portion 112d, 112b thereof. In some embodiments, the fourth neck diameter 112-1d and/or the second neck wall thickness 112-2b may be configured to provide strength and/or rigidity to the respective neck portions 112d, 112b. The respective neck portions 112d, 112b may be utilized as mounting and/or engagement devices to mate with one or more administration assemblies (not shown—e.g., the “administration component 130” of U.S. patent application Ser. No. 17/960,111 titled SYSTEMS AND METHODS FOR PRE-FILLED MEDICAL DELIVERY DEVICES and filed on Oct. 4, 2022, the administration component/assembly descriptions of which are hereby incorporated by reference herein), for example, and rigidity may improve the connection/coupling performance thereof.

With exemplary reference to a perspective radial cross-section of the BFS vial system 100 shown in FIG. 1D, the fifth BFS vial 110e may comprise and/or define a fifth chamber diameter 122-1e and/or a first BFS vial 110a may comprise and/or define a first chamber wall thickness 122-2a, each at a respective chamber portion 122a, 122e thereof. The chamber portions 122a, 122e may comprise, for example, portions of the BFS vials 110a, 110e that are configured to provide a fluid inspection area (or volume) and the fifth chamber diameter 122-1e and/or the first chamber wall thickness 122-2a may be configured to facilitate, e.g., visual inspection of the BFS vials 110a, 110e. In some embodiments, the chamber portions 122a, 122e may be disposed at (and/or encompassing) an axial position along the BFS vials 110a, 110e that is coincident with a location of a mold separation line (not separately shown). While the portions of the BFS vial system 100 disposed and/or formed from the second end of the BFS vials 110a, 110e (e.g., the respective label tabs 126a, 126e) may be formed by a first mold body (not shown; e.g., a primary or “main” two-part mold body), for example, the other/upper portions of the BFS vials 110a, 110e terminating at the first end thereof may be formed by a secondary or “head” mold (also not shown). The separation line between the two molds (or mold portions) may, for example, be coincident with (or near) the cut-plane of the cross-section shown in FIG. 1D. In such embodiments, the chamber portions 122a, 122e may be designed to have the specific fifth chamber diameter 122-1e and/or the first chamber wall thickness 122-2a to facilitate the molding process at the mold separation line. In some embodiments, one or more of the fifth chamber diameter 122-1e and/or the first chamber wall thickness 122-2a may be configured to facilitate and/or permit or enable a filling mandrel (not shown) to fill the BFS vials 110a, 110e, e.g., after the formation of the lower portions of the BFS vials 110a, 110e but before formation/closing of the upper portions of the BFS vials 110a, 110e. The fifth chamber diameter 122-1e may be sized, for example, to permit a filling mandrel to enter the chamber portions 122a, 122e without engaging with the side-walls thereof (e.g., designed to permit no interference and/or to provide clearance for the filling mandrels). According to some embodiments, the fifth chamber diameter 122-1e may be between seven millimeters (7-mm) and nine and two tenths millimeters (9.2-mm). The fifth chamber diameter 122-1e may be configured, for example, to be seven and eighty-five hundredths millimeters (7.85-mm) with a variation of plus or minus two tenths of a millimeter (+−0.20-mm).

With exemplary reference to a perspective radial cross-section of the BFS vial system 100 shown in FIG. 1E, the first BFS vial 110a may comprise and/or define a first reservoir diameter 120-1a (or length), a second reservoir diameter 120-3a (or width), and/or a first squeeze surface 120-4a, and/or the fifth BFS vial 110e may comprise and/or define a fifth reservoir wall thickness 120-2e and/or one or more fifth reservoir grip elements 120-5e, each at a respective fluid reservoir 120a, 120e thereof. In some embodiments, the fluid reservoirs 120a, 120e may be specially configured to achieve a squeeze-force rating that is within a predetermined target squeeze-force threshold range. It may be desirable, such as in the case that the BFS vials 110a, 110e are utilized for injectable medicament delivery for example, for the fluid reservoirs 120a, 120e to be radially compressible to a degree such that a target amount of fluid is expelled from the fluid reservoirs 120a, 120e. In the case that the fluid reservoirs 120a, 120e are filled with a single dose of a vaccine in the range of one half milliliter (0.5-ml) to one and one half milliliters (1.5-ml), for example, it may be desirable for a radial squeezing/compression of the fluid reservoirs 120a, 120e to result in a certain designed amount and/or percentage of the vaccine to be expelled during an administration process. In some embodiments, the single dose of vaccine and/or the fluid filled in the fluid reservoirs 120a, 120e may be approximately one and one tenth milliliters (1.1-ml). According to some embodiments, the fluid reservoirs 120a, 120e may be designed such that a squeeze-force of between thirty newtons (30-N) and forty-five newtons (45-N) is capable of compressing the fluid reservoirs 120a, 120e to such an extent that only a small percentage (e.g., less than twenty percent (20%), less than ten percent (10%), and/or less than five percent (5%) and/or volume of fluid or medicament remains in the fluid reservoirs 120a, 120e. In the case of a desired medicament dosage of one half milliliter (0.5-ml), for example, the fluid reservoirs 120a, 120e may be filled with an over-dose of six tenths of a milliliter (0.6-ml) such that compression of the fluid reservoirs 120a, 120e results in the desired delivered dosage amount one half milliliter (0.5-ml) being expelled. According to some embodiments, the first reservoir diameter (length) 120-1a may be configured to be twelve and sixty-three hundredths millimeters (12.63-mm) with a variation of plus or minus five one and five hundredths of a millimeter (+−1.05-mm), for example, and/or the second reservoir diameter (width) 120-3a may be configured to be eleven and two tenths millimeters (11.20-mm) with a variation of plus or minus twenty-five hundredths of a millimeter (+−0.25-mm). The ratio of the first reservoir diameter (length) 120-1a to the second reservoir diameter (width) 120-3a may, in some embodiments, be between one and six hundredths (1.06) or one to ninety-five hundredths (1:0.95) and one and nineteen hundredths (1.19) or one to eighty-four hundredths (1:0.84). In the case that the first reservoir diameter (length) 120-1a is twelve and sixty-three hundredths millimeters (12.63-mm) and the second reservoir diameter (width) 120-3a is eleven and two tenths millimeters (11.20-mm), for example, the ratio may be one to eighty-nine hundredths (1:0.89).

In some embodiments, such as in the case of injectable medicines, if the squeeze-force required to compress the fluid reservoirs 120a, 120e is too high, users may not successfully expel the targeted dose of fluid (i.e., too much fluid may be retained in the fluid reservoirs 120a, 120e). Previous compressible BFS applications were generally agnostic to squeeze-force considerations as they either did not utilize compression as an administration mechanism (e.g., applied vacuum via a syringe) and/or the expelled dosage was not of importance. In the case of BFS injectables, however, and particularly for those injectables that utilize radially-inward compression to expel fluids, the squeeze-force required to achieve compression (e.g., collapsing of the fluid reservoirs 120a, 120e) may affect the amount of fluid expelled (i.e., the delivered dosage). In some embodiments, such as depicted in FIG. 1E, the first reservoir diameter (length) 120-1a, the second reservoir diameter (width) 120-3a, the first squeeze surface 120-4a, and/or the fifth reservoir wall thickness 120-2e, may be configured to achieve a desired squeeze-force range. The first reservoir diameter (length) 120-1a and/or the second reservoir diameter (width) 120-3a (and/or a portion of the height “H”) may be configured to provide for a volume in excess of the designed medicament capacity, for example, which may result in one or more effects that reduce the squeeze-force needed to achieve full compression. Increasing the length and/or width (and/or height) dimensions 120-1a, 120-3a may generally cause a thinning of the fifth reservoir wall thickness 120-2e, for example, by stretching the available plastic resin (e.g., a fixed value for a given BFS molding process) over a larger area. Increasing the volume of the fluid reservoirs 120a, 120e may also (or alternatively) increase a liquid-to-air ratio, in the case that the fluid reservoirs 120a, 120e are filled with a combination of a liquid medicament and a gas (e.g., air). In some embodiments, for example, a liquid-to-air ratio of the fluid reservoirs 120a, 120e (and/or the BFS vials 110a, 110e) may be between one to five and one quarter (1:5.25) and one to two and fifteen hundredths (1:2.15). In some embodiments, having liquid-to-air ratios in excess of one to two (1:2) may permit (e.g., due to the compressibility of the air and/or other gas) a pressure to be developed inside of the fluid reservoirs 120a, 120e (e.g., upon compression), which may assist in expelling the desired dosage. The larger volume of gas/air may, for example, provide an advantageous compressible driver to expel the liquid from the fluid reservoirs 120a, 120e. According to some embodiments, the liquid-to-air ratio may be configured to be one to two and one half (1:2.5). According to some embodiments, the liquid-to-air ratio may be configured to be one to five (1:5). In some embodiments, the fifth reservoir wall thickness 120-2e may be between four tenths (0.4-mm) of a millimeter and seven tenths of a millimeter (0.7-mm). In some embodiments, the fifth reservoir wall thickness 120-2e may be configured to be fifty-five hundredths of a millimeter (0.55-mm) with a variation of plus or minus fifteen hundredths of a millimeter (+−0.15-mm).

According to some embodiments, and with exemplary reference to a top radial cross-section of the BFS vial system 100 shown in FIG. 1F, the first BFS vial 110a may comprise and/or define a first fluid reservoir 120a configured with a low arch cross-section. The first fluid reservoir 120a may comprise and/or define, for example, the second reservoir diameter (width) 120-3a extending between opposing side flanges 118a (externally as shown, or internally) and the first reservoir diameter (length) 120-1a extending normal to the second reservoir diameter (width) 120-3a and between opposing first squeeze surfaces 120-4a (and/or first reservoir grip elements 120-5a). In some embodiments, the first reservoir diameter (length) 120-1a may be greater than the second reservoir diameter (width) 120-3a, as depicted. The second reservoir diameter (width) 120-3a may be between eleven and two tenths millimeters (11.2-mm) and twelve and twelve and eight tenths millimeters (12.8-mm), for example, and the first reservoir diameter 120-1a (or length) may be between twelve and sixty-three hundredths millimeters (12.63-mm) and fourteen and one half millimeters (14.5-mm). In some embodiments, the first reservoir diameter (length) 120-1a and the second reservoir diameter (width) 120-3a may be configured to form the low arch cross-section depicted at the opposing first squeeze surface 120-4a ends of the cross-sectional shape of the first fluid reservoir 120a. The first BFS vial 110a may comprise and/or define, for example, an arch length 120-6a that extends between the sidewalls of the first fluid reservoir 120a and an arch height 120-7a that extends from a springing line “A” to the extent of the first fluid reservoir 120a (e.g., at the first squeeze surface 120-4a). In some embodiments, the low arch cross-section may comprise and/or define a segmental arch with a length to height ratio of approximately twelve to one (12:1). According to some embodiments, the arch height 120-7a may be less than one eighth (⅛^{th}) of the arch length 120-6a, such that the arch may be prone to collapse upon receiving an inward radial force. In such a manner, for example, as opposed to employing a stronger circular or arch shape such as an elliptical arch, the squeeze-force required to collapse the first fluid reservoir 120a may be less than for other cross-sectional shapes. In the case of “soft” plastic utilized in the BFS process, the sidewalls may provide very little support for the ends of the arch and may accordingly facilitate the designed structural failure that permits the compression/collapsing of the first fluid reservoir 120a.

While reference to different dimensions and/or geometries is made herein with respect to specific BFS vials 110a-e, in some embodiments any or all of the BFS vials 110a-e and/or the BFS vial system 100 may comprise and/or define the described dimensions, geometries, and/or attributes-e.g., configured to result in a designed radial squeeze-force. Similarly, while the BFS vial system 100 is depicted with five (5) BFS vials 110a-e, in some embodiments fewer or more BFS vials 110a-e may be configured to be molded together in a single “card”. The BFS vial system 100 or “card” may, for example, comprise ten (10) or twenty-five (25) BFS vials 110a-e, depending upon BFS machine and/or mold characteristics, design, and/or configuration. The BFS vials 110a-e and/or the BFS vial system 100 may, for example, be manufactured utilizing a rotary BFS machine such as, but not limited to: (i) a carousel-style rotary machine such as the Bottelpack™ bp460-20 machine from Rommelag Kunststoff-Maschinen Vertriebsgesellschaft mbH of Waiblingen, Germany, that utilize counter-rotating chains of cooperative mold halves and (ii) a hybrid-style rotary machine such as the Bottelpack™ bp434 machine from Rommelag Kunststoff-Maschinen Vertriebsgesellschaft mbH of Waiblingen, Germany. While the BFS manufacturing process is commonly referred to as “Blow-Fill-Seal” or “BFS” as referenced herein, BFS product processes may utilize blown air and/or vacuum to engage the parison with the mold cavities (not shown) of the cooperative mold halves. A BFS machine that manufactures the BFS vial system 100 may comprise, for example, a vacuum device such as one or more of a vacuum pump, vacuum tubes, fittings, hoses, and/or connections that are coupled to selectively apply vacuum force to the mold halves, e.g., drawing the parison material into the cavities of the molds to form the BFS vial system 100, the BFS vials 110a-e, and/or any components and/or portions thereof.

In some embodiments, the BFS vials 110a-e (and/or the BFS vial system 100) may be formed of one or more polyolefins such as Low-Density PolyEthylene (LDPE), High-Density PolyEthylene (HDPE), and/or PolyPropylene (PP) and/or one or more other thermoplastics such as Thermoplastic PolyUrethane (TPU). The BFS vials 110a-e may, for example, be comprised of a “soft” plastic, e.g., having a Shore/Durometer “D” hardness of between 60 and 70.

In some embodiments, a fluid or drug agent sealed within the BFS vials 110a-e may include any type of agent to be injected into a patient (e.g., mammal, either human or non-human, or any other animal) and capable of producing an effect (alone, or in combination with an active ingredient). Accordingly, the agent may include, but is not limited to, a vaccine, a drug, a therapeutic agent, a medicament, a diluent, and/or the like. According to some embodiments, either or both of a fluid agent and an active ingredient (i.e., the drug agent and/or components thereof) may be tracked, monitored, checked for compatibility with each other, etc., such as by utilization of electronic data storage devices (not shown) coupled to one or more of the various components of the BFS vial system 100.

In some embodiments, fewer or more components 110a-e, 112b-e, 112-1c, 112-1d, 112-2b, 112-2c, 114c, 114e, 114-1c, 116e, 118a, 118e, 120a, 120c, 120e, 120-1a, 120-1c, 120-2c, 120-2e, 120-3a, 120-4a, 120-5a, 120-5e, 120-6a, 120-7a, 122a, 122e, 122-1e, 122-2a, 126a, 126c, 126e, 126-1c and/or various configurations of the depicted components 110a-e, 112b-e, 112-1c, 112-1d, 112-2b, 112-2c, 114c, 114e, 114-1c, 116e, 118a, 118e, 120a, 120c, 120e, 120-1a, 120-1c, 120-2c, 120-2e, 120-3a, 120-4a, 120-5a, 120-5e, 120-6a, 120-7a, 122a, 122e, 122-1e, 122-2a, 126a, 126c, 126e, 126-1c may be included in the BFS vial system 100 without deviating from the scope of embodiments described herein. In some embodiments, the components 110a-e, 112b-e, 112-1c, 112-1d, 112-2b, 112-2c, 114c, 114e, 114-1c, 116e, 118a, 118e, 120a, 120c, 120e, 120-1a, 120-1c, 120-2c, 120-2e, 120-3a, 120-4a, 120-5a, 120-5e, 120-6a, 120-7a, 122a, 122e, 122-1e, 122-2a, 126a, 126c, 126e, 126-1c may be similar in configuration and/or functionality to similarly named and/or numbered components as described herein. According to some embodiments, the BFS vial system 100 may comprise the fluid reservoirs 120a, 120c, 120e but not the chamber portions 122a, 122e. In some embodiments, the label tabs 126a, 126c, 126e may not be included. According to some embodiments, the mounting collar 116e may not be included, e.g., as the mounting of the BFS vials 110a-e to one or more administration assemblies (not shown) may be accomplished and/or facilitate by one or more other elements such as the side flanges 118a, 118e.

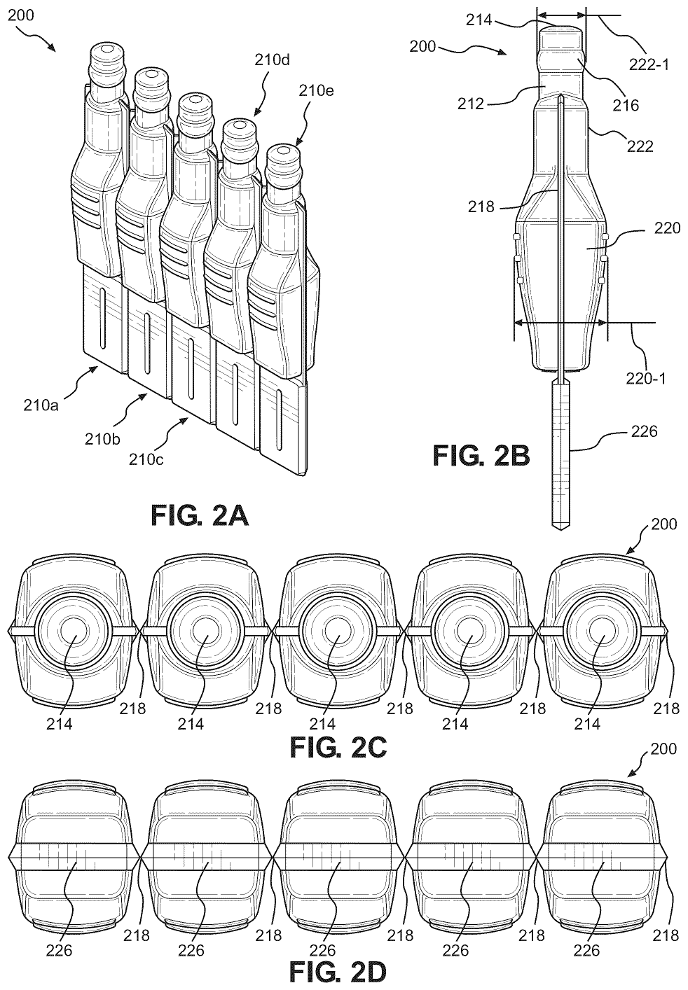

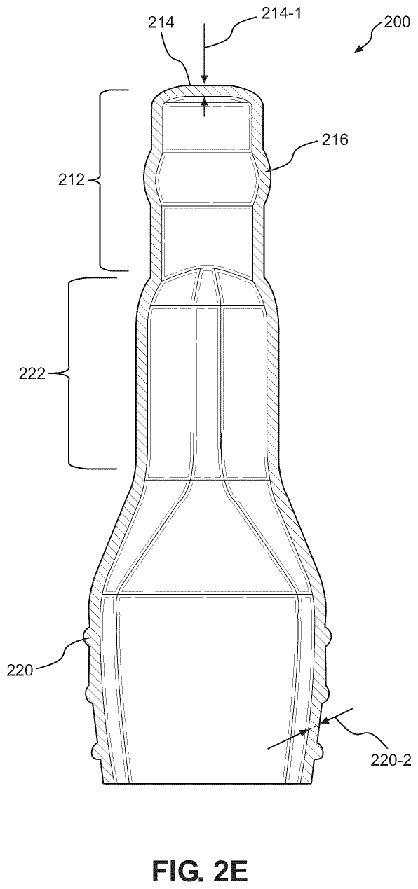

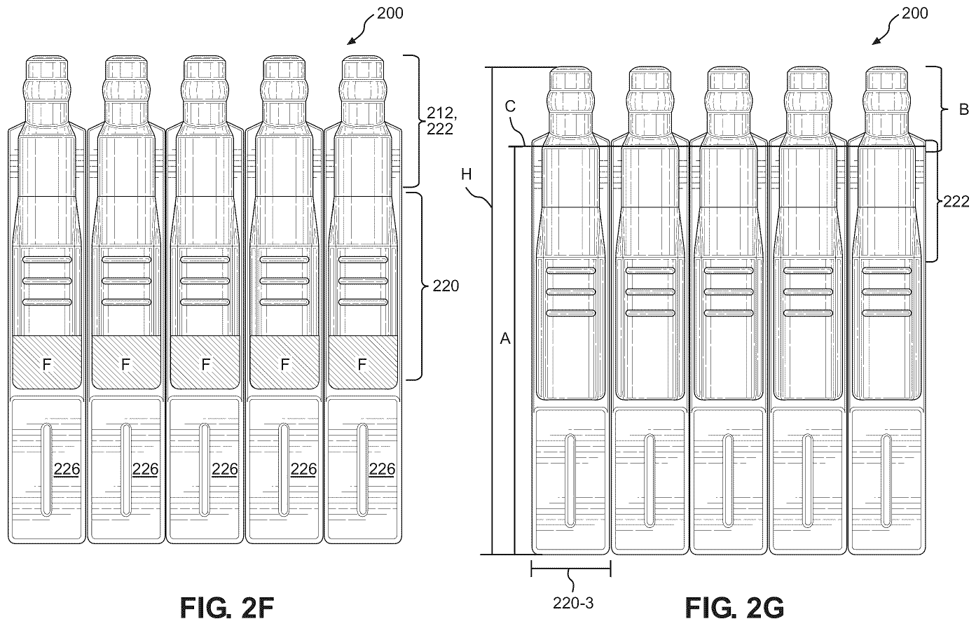

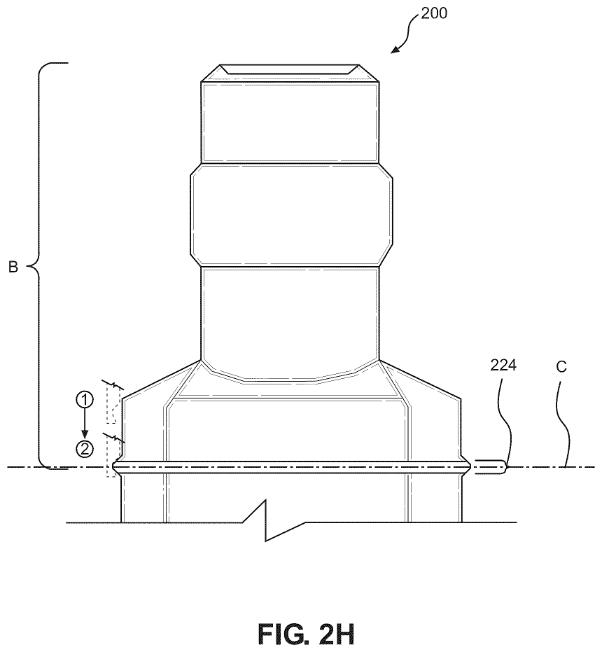

Referring now to FIG. 2A, FIG. 2B, FIG. 2C, FIG. 2D, FIG. 2E, FIG. 2F, FIG. 2G, and FIG. 2H, various views of a BFS vial system 200 according to some embodiments are shown. In some embodiments, the BFS vial system 200 may be similar in configuration to the BFS vial system 100 of FIG. 1A, FIG. 1B, FIG. 1C, FIG. 1D, FIG. 1E, and FIG. 1F herein. The BFS vial system 200 may comprise, for example, a plurality of BFS vials 210a-e molded together to form a “card” of BFS product, as depicted in a perspective view of FIG. 2A. In some embodiments, the plurality of BFS vials 210a-e may be specifically shaped and/or configured to achieve a designed squeeze-force range for compression of the plurality of BFS vials 210a-e. Each BFS vial 210a-e may comprise and/or define, as depicted in a side view of FIG. 2B, a top view of FIG. 2C, and/or a bottom view of FIG. 2D, in some embodiments, a neck portion 212 sealed at one end via a fluid seal 214, a mounting flange 216, and/or “wings” or side flanges 218. According to some embodiments, the BFS vials 210a-e may also or alternatively comprise a fluid reservoir 220 and/or a chamber portion 222 in fluid communication with each other and/or with the neck portion 212. Each of the neck portion 212, the fluid reservoir 220, and the chamber portion 222 may, for example, define interior volumes (not separately labeled) that house and/or retain one or more of a liquid, a solid, and a gas. In some embodiments, and as depicted in a partial side cross-sectional view of FIG. 2E, the fluid seal 214 may comprise and/or define a seal thickness 214-1. The seal thickness 214-1 may, for example, be between four tenths of a millimeter (0.4-mm) and nine tenths of a millimeter (0.9-mm). In some embodiments, the seal thickness 214-1 may be approximately sixty-five hundredths of a millimeter (0.65-mm) and/or with a variation of plus or minus twenty-five hundredths of a millimeter (+−0.25-mm). The seal thickness 214-1 (and/or the fluid seal 214) may be configured and/or designed, for example, to facilitate axial piercing of the BFS vials 210a-e, e.g., by a piercing element of an administration member (neither of which are shown).

According to some embodiments, and referring back to FIG. 2B, the fluid reservoir 220 may comprise and/or define a reservoir diameter 220-1 (e.g., outside diameter or dimension as-depicted, or inside diameter/dimension) and/or radial dimension in the range of between twelve and sixty-five hundredths millimeters (12.65-mm) and fourteen and seventy-five hundredths millimeters (14.75-mm). In some embodiments, the reservoir diameter 220-1 may be approximately thirteen and seventy-three hundredths millimeters (13.73-mm) and/or with a variation of plus or minus one and five hundredths of a millimeter (+−1.05-mm). According to some embodiments, the chamber portion 222 may comprise and/or define a chamber diameter 222-1 of between seven and fifty-two hundredths millimeters (7.52-mm) and eight and forty-two hundredths millimeters (8.42-mm). In some embodiments, the chamber diameter 222-1 may be approximately seven and eighty-five hundredths millimeters (7.85-mm) and/or with a variation of plus or minus twenty hundredths of a millimeter (+−0.20-mm). These dimensions (or ranges of dimensions) may, for example, permit the fluid reservoir 220 to be radially compressed in accordance with a designed compression or squeeze-force of approximately thirty-eight and four tenths Newtons (38.4-N); e.g., thirty-eight Newtons (38-N). In some embodiments, the dimensions (or ranges thereof) combined with strategically configured wall thicknesses of the BFS vials 210a-e may enable the designed squeeze-force. With reference back to FIG. 2E, for example, the fluid reservoir 220 may be molded with a reservoir wall thickness 220-2 of between four tenths of a millimeter (0.4-mm) and seven tenths of a millimeter (0.7-mm). According to some embodiments, the reservoir wall thickness 220-2 may be approximately fifty-five hundredths of a millimeter (0.55-mm). In some embodiments, the combination of the dimensions, geometry, and reservoir wall thickness 220-2 of the BFS vials 210a-e may enable a designed range of radially compressive forces to be applied to the BFS vials 210a-e with a high likelihood (e.g., statistically) that a designed output dosage of medicament (e.g., five tenths of a milliliter (0.5-ml) is provided to a patient.

In some embodiments, the BFS vials 210a-e may be filled (e.g., via a BFS process) with a combination of a fill amount of liquid medicament and a volume of air. In some embodiments, the liquid-to-air ration within the BFS vials 210a-e may be approximately one to four and sixty-nine hundredths (1:4.69). As depicted in a front view of FIG. 2F, for example, an amount of medicament fluid “F” may be filled into the fluid reservoirs 220, e.g., with the BFS vials 210a-e positioned with the fluid seals 214 facing upwards (e.g., vertically oriented, although not necessarily aligned in parallel with the force of gravity). While the BFS vials 210a-e may be filled (e.g., before being sealed/fully formed) in either an “upright” position (as depicted in FIG. 2F) or in an “inverted” position, in some embodiments the BFS vials 210a-e may be filled in the upright position so that design constraints related to mold separation areas/lines are avoided or minimized for the fluid reservoirs 220. As depicted in a front view of FIG. 2G, for example, a first portion “A” of the BFS vials 210a-e and/or the BFS vial system 200 may be formed by a first, primary, or main mold (not shown) and a second portion “B” of the BFS vials 210a-e and/or the BFS vial system 200 may be formed by a second, secondary, or head mold (also not shown), with a mold separation weld line “C” passing through (in the case of upright filling) the chamber portions 222. According to some embodiments, such as in the case that a total height “H” of the BFS vials 210a-e and/or the BFS vial system 200 is approximately seventy-six millimeters (76-mm), the mold separation weld line “C” may be positioned approximately sixty-three millimeters (63-mm) from the second or lower ends or extents of the BFS vials 210a-e and/or the BFS vial system 200. In some embodiments, the fluid reservoirs 220 may also or alternatively comprise and/or define (e.g., in the case that the fluid reservoirs 220 are not circular in cross-section) a reservoir width 220-3 (e.g., outside diameter or dimension as-depicted, or inside diameter/dimension) and/or radial dimension in the range of between eleven and ninety-five hundredths millimeters (11.95-mm) and twelve and fifty-five hundredths millimeters (12.55-mm). In some embodiments, the reservoir width 220-3 may be approximately twelve and thirty hundredths millimeters (12.30-mm). In some embodiments, the reservoir width 220-3 (internal or external dimension) may be approximately eleven and six tenths millimeters (11.6-mm) and/or a length of the fluid reservoir 220 (not separately labeled) may be approximately thirteen millimeters (13.0-mm).

According to some embodiments, and with reference to FIG. 2H, the mold separation weld line “C” may correspond with a mold separation flange or ridge 224. The mold separation ridge 224 may, for example, comprise a raised formation of fused plastic that is thicker than surrounding molded features due to aggregation of the parison along the seam (the mold separation weld line “C”) where mold halves come together. In some embodiments, the mold separation ridge 224 may be advantageously positioned and/or utilized. In a case where an administration assembly (not shown; e.g., the “hub connector 14” and/or the “alignment tracks 44” thereof, as described in co-pending International Patent Application No. PCT/US23/25123 titled “MEDICAL DELIVERY ASSEMBLY”, the BFS connector concepts of which are hereby incorporated by reference herein) is coupled and/or mated with the first BFS vial 210a depicted in FIG. 2H, for example, the mold separation ridge 224 may be utilized to position, index, and/or couple and/or mate the first BFS vial 210a with the administration assembly. In some embodiments, a portion of the administration assembly such as a hook or detent or a portion having a feature otherwise configured to engage with the mold separation ridge 224 (e.g., a feature formed and/or disposed within a socket of the administration assembly), such as depicted in dotted lines in FIG. 2H, may be engaged with the mold separation ridge 224. The feature may advance from a first position “1” axially removed from the mold separation ridge 224, for example, and then be advanced to a second position “2” where the mold separation ridge 224 has been seated in or otherwise engaged with the feature. According to some embodiments, the feature may be configured to latch onto the mold separation ridge 224 such that removal of the administration member may be inhibited. In some embodiments, engagement of the feature with the mold separation ridge 224 may produce an audible and/or tactile response such as a “click” that may inform a user (not shown) that the administration member has been engaged with the mold separation ridge 224. As depicted in FIG. 2H, the portions of the mold separation ridge 224 engaged by the feature may comprise radially distal extents of the mold separation ridge 224 situated on the opposing side flanges 218 of the first BFS vial 210a.

In some embodiments, fewer or more components 210a-e, 212, 214, 214-1, 216, 218, 220, 220-1, 220-2, 220-3, 222, 222-1, 224, 226 and/or various configurations of the depicted components 210a-e, 212, 214, 214-1, 216, 218, 220, 220-1, 220-2, 220-3, 222, 222-1, 224, 226 may be included in the BFS vial system 200 without deviating from the scope of embodiments described herein. In some embodiments, the components 210a-e, 212, 214, 214-1, 216, 218, 220, 220-1, 220-2, 220-3, 222, 222-1, 224, 226 may be similar in configuration and/or functionality to similarly named and/or numbered components as described herein. According to some embodiments, the BFS vial system 200 may comprise the fluid reservoirs 220 but not the chamber portions 222. In some embodiments, the label tabs 226 may not be included. According to some embodiments, the mounting flange/collar 216 may not be included, e.g., as the mounting of the BFS vials 210a-e to one or more administration assemblies (not shown) may be accomplished and/or facilitate by one or more other elements such as the side flanges 218.

### III. BFS Radial Squeeze-Force Design Considerations

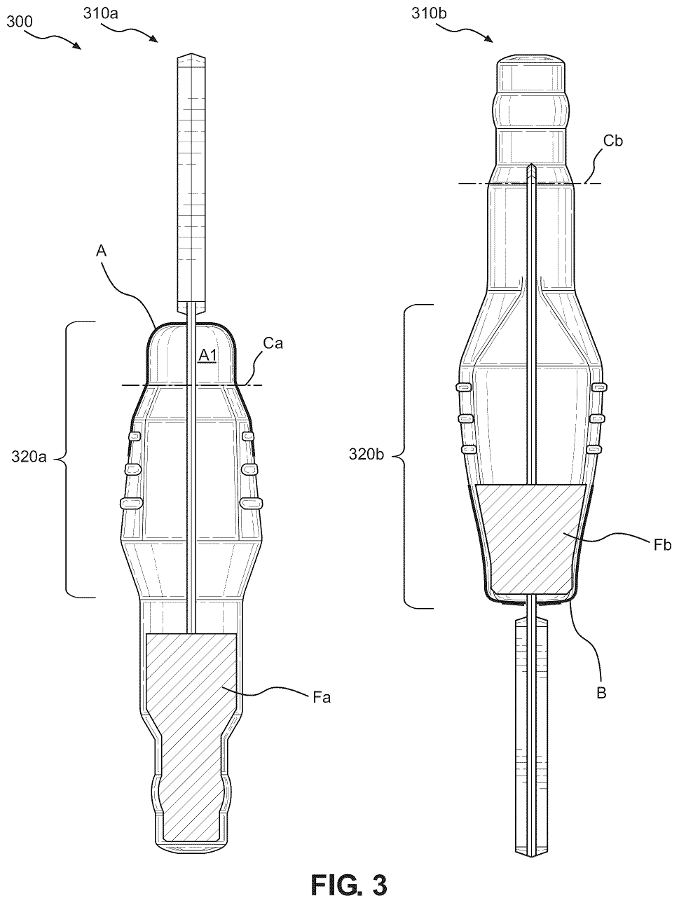

Turning to FIG. 3, a BFS vial system 300 with side views depicting design differences between two (2) different BFS vials 310a-b is shown. A first BFS vial 310a may, for example, depict a design configured for “inverted” (or “up-side down”) filling such that a first fluid level “Fa” is deposited in the first BFS vial 310a as shown. In some embodiments, a second BFS vial 310b may depict a design configured for “upright” (or “right-side up”) filling such that a second fluid level “Fb” is deposited in the second BFS vial 310b as shown. Due to the nature of the BFS process, and particularly in relation to the utilization of multi-part molds (not shown) utilized to form and seal the BFS vials 310a-b, different design constraints are relevant for the two (2) different BFS vials 310a-b. In the case of inverted filling for the first BFS vial 310a, for example, a first fluid reservoir 320a of the first BFS vial 310a may be required to comprise and/or define a first shape profile “A”, as depicted. The first shape profile “A” may, for example, comprise a non-uniform taper, a concavity, and/or a cylindrical or rounded end-section “A1” of the first fluid reservoir 320a, e.g., to prevent problems associated with a first mold separation line “Ca” disposed across the first fluid reservoir 320a as shown. In order to achieve proper molding and/or plastic fusion/welding characteristics at the first mold separation line “Ca”, for example, the terminal portion of the first fluid reservoir 320a may need to comprise the cylindrical section “A1” shown (and a transition from the tapered section to the cylindrical section).

In contrast, the second BFS vial 310b being configured for upright filling may comprise and/or define a second fluid reservoir 320b that may comprise and/or define a second shape profile “B”, as depicted. The second shape profile “B” may, for example, comprise a uniform taper and/or may not require any cylindrical or rounded end-section of the second fluid reservoir 320b. As a second mold separation line “Cb” for upright filling may occur axially distal from the second fluid reservoir 320b, for example, the shape of the end portion of the second fluid reservoir 320b may be free of constraints due to the second mold separation area/line “Cb”. According to some embodiments, the second shape profile “B” may be more desirable than the first shape profile “A”. The second shaped profile “B” may, for example, provide less axial resistance to facilitate easier squeezing of the second fluid reservoir 320b. the first fluid reservoir 320a may require a first squeeze force to achieve radially-inward compression, for example, while the second fluid reservoir 320b may require a second squeeze force to achieve radially-inward compression, wherein the second squeeze force is less than the first squeeze force, e.g., due to less structural squeeze resistance due to the shape of the second shaped profile “B”.

In some embodiments, fewer or more components 310a-b, 320a-b and/or various configurations of the depicted components 310a-b, 320a-b may be included in the BFS vial system 300 without deviating from the scope of embodiments described herein. In some embodiments, the components 310a-b, 320a-b may be similar in configuration and/or functionality to similarly named and/or numbered components as described herein.

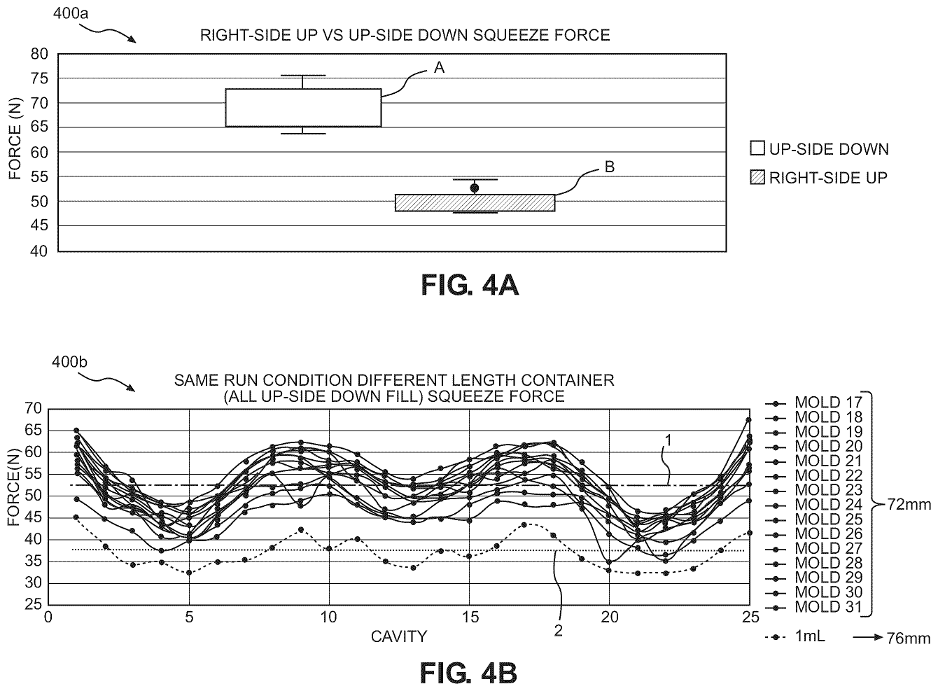

Referring to FIG. 4A and FIG. 4B, for example, graphs 400a-b showing example test results for BFS vial designs are shown. In a first graph 400a in FIG. 4A, a range of squeeze-forces (e.g., required to compress/collapse the reservoirs 320a-b) measured with respect to the designs of the BFS vials 310a-b of FIG. 3 shows that an inverted/up-side down filing design (i.e., the first BFS vial 310a) resulted in a first range of squeeze-forces “A” ranging between about sixty-five newtons (65-N) and seventy-three newtons (73-N) and shows that an upright/right-side up filing design (i.e., the second BFS vial 310b) resulted in a second range of squeeze-forces “B” ranging between about forty-eight Newtons (48-N) and fifty-one Newtons (51-N). While not depicted, subsequent testing has revealed that the second range of squeeze-forces “B” can range between about thirty-four Newtons (34-N) and thirty-nine Newtons (39-N) in some cases. Accordingly, in the case that lower squeeze-forces are desired, it has been determined that the second BFS vial 310b (and respective second shape profile “B” of the second fluid reservoir 320b) may be more desirable than the first BFS vial 310a (and respective first shape profile “A” of the first fluid reservoir 320a). The first shape profile “A” of the first fluid reservoir 320a may, for example, add structural rigidity to the first fluid reservoir 320a, making the first fluid reservoir 320a harder to squeeze.

According to some embodiments, the overall height of the BFS vials 310a-b (and/or of the fluid reservoirs 320a-b) may also or alternatively affect squeeze-forces required to compress/collapse the fluid reservoirs 320a-b. As depicted in a second graph 400b in FIG. 4B, for example, results are shown for squeeze-force testing for a variety of BFS vials (not shown) produced utilizing different molds and for different overall BFS vial height. BFS vials molded to have an overall height of approximately seventy-two millimeters (72-mm), for example, resulted in an average required squeeze-force (shown as estimated trend line “1”) of about fifty-three Newtons (53-N), while BFS vials molded to have an overall height of approximately seventy-six millimeters (76-mm) resulted in an average required squeeze-force (shown as estimated trend line “2”) of about thirty-seven Newtons (37-N). Accordingly, it has been determined that longer/higher BFS vials may be more desirable in lowering squeeze-forces of fluid reservoirs thereof.

According to some embodiments, any or all of the following BFS vial and/or BFS manufacturing characteristics may be adjusted to produce a BFS vial design that meets a desired/target squeeze-force constraint: (i) BFS vial height/length, width, and/or wall thickness, (ii) fluid reservoir height/length, width, and/or wall thickness, (iii) fluid reservoir cross-sectional geometry (e.g., low arch as opposed to circular or elliptical cross-section), and/or (iv) filling orientation (and/or geometric constraints thereof and/or geometric parameters related thereto—e.g., fluid reservoir shape profiles). Balancing all of the factors that affect squeeze-force for a BFS vial is a complicated process. Each factor/variable affects other characteristics of the BFS vial, for example, and making changes to accommodate squeeze-force design constraints cannot accordingly be expected to result in a successful product as the chosen values may cause failure of the BFS vial in other aspects. Providing a low arch profile for a fluid reservoir to decrease required squeeze-force parameters, for example, was expected to cause problems with release of the flatter-shaped reservoir portions from the molds, and making wall thickness too low can result in structural failure that results in product/medicament contamination and/or leakage.

In some embodiments, the designed or target squeeze force may be set to fall within a range configured for certain use cases and/or expected users. In the case of radially compressible BFS vials as described herein, for example, the designed squeeze-force may vary from a low measured/expected force applicable to a child (e.g., in the range of nine Newtons (9-N) to thirty-nine Newtons (39-N)) to a high measured/expected squeeze-force applicable to an adult male (e.g., in the range of forty-nine Newtons (49-N) to one hundred and twelve Newtons (112-N)). In some embodiments, the designed squeeze-force may be set to a predetermined percentage of a measured and/or expected pinch, grip, and/or squeeze force of a target user such as a user of a specific age range and/or gender. According to some embodiments, for example, the designed squeeze-force may be set to between thirty Newtons (30-N) and forty-five Newtons (45-N). In some embodiments, the designed squeeze-force may be set at between eighty percent (80%) and eighty-five percent (85%) of a measured/expected squeeze-force for a target group of users such as Registered Nurse (RN) and/or pharmacist practitioners. In the case that an average user is expected to be a female of approximately fifty (50) years of age, for example, and with a measured/expected squeeze-force (e.g., average or maximum) of approximately forty-six Newtons (46-N), a weighted/adjusted design squeeze-force may be approximately thirty-eight and four tenths Newtons (38.4-N)—e.g., forty-six Newtons (46-N) times a weighting factor of eighty-three percent (83%). In some embodiments, expected/estimated/measured squeeze-force data may be derived from various sources such as, but not limited to, “Human factors engineering—Design of medical devices”, American National Standards Institute, Inc. (ANSI)/Association for the Advancement of Medical Instrumentation (AAMI) HE75: 2009, published by AAMI of Arlington, VA (2010): ISBN 1-57020-364-4 and/or Imrhan, Sheik N., et al., :Trends in Finger Pinch Strength in Children, adults, and the Elderly”, Human Factors, 31(6), 689-701, published by the Human Factors Society, Inc. (1989).

### IV. Rules of Interpretation

Throughout the description herein and unless otherwise specified, the following terms may include and/or encompass the example meanings provided. These terms and illustrative example meanings are provided to clarify the language selected to describe embodiments both in the specification and in the appended claims, and accordingly, are not intended to be generally limiting. While not generally limiting and while not limiting for all described embodiments, in some embodiments, the terms are specifically limited to the example definitions and/or examples provided. Other terms are defined throughout the present description.

All definitions, as defined and used herein, should be understood to control over dictionary definitions, definitions in documents incorporated by reference, and/or ordinary meanings of the defined terms.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention that must be present in all embodiments.

Neither the Title (set forth at the beginning of the first page of this patent application) nor the Abstract (set forth at the end of this patent application) is to be taken as limiting in any way as the scope of the disclosed invention(s).

As used herein, the term “coupled” may generally refer to any type or configuration of coupling that is or becomes known or practicable. Coupling may be descriptive, for example, of two or more objects, devices, and/or components that are communicatively coupled, mechanically coupled, electrically coupled, and/or magnetically coupled. The term “communicatively coupled” generally refers to any type or configuration of coupling that places two or more objects, devices, components, or portions, elements, or combinations thereof in communication. Mechanical, electrical, fluid, and magnetic communications are examples of such communications. The term “mechanically coupled” generally refers to any physical binding, adherence, attachment, and/or other form of physical contact between two or more objects, devices, components, or portions, elements, or combinations thereof. The term “electrically coupled” indicates that one or more objects, devices, components, or portions, elements, or combinations thereof, are in electrical contact such that an electrical signal, pulse, or current (e.g., electrical energy) is capable of passing between the one or more objects, enabling the objects to electrically communicate with one another. In some embodiments, electrical coupling may enable electrical energy to be transmitted wirelessly between two or more objects and/or devices. The term “magnetically coupled” indicates that one or more objects, devices, components, or portions, elements, or combinations thereof, are within one or more associated magnetic fields. Objects may be electrically and/or magnetically coupled without themselves being physically attached or mechanically coupled. For example, objects may communicate electrically through various wireless forms of communication or may be within (at least partially) a magnetic field, without being physically touching or even adjacent.

References to “interior” or “exterior” are references to areas and/or portions of an object with respect to other features such as holes, volumes, ports, passages, conduits, etc. Such objects necessarily comprise and/or define various “surfaces” such as an interior, exterior, inner, outer, inside, and/or outside surface. References to the different areas and/or portions are accordingly also references to the associated surfaces.

Directions and other relative references may be used to facilitate discussion of the drawings and principles herein, but are not intended to be limiting. For example, certain terms may be used such as “inner,” “outer,”, “upper,” “lower,” “top,” “bottom,” “interior,” “exterior,” “left,” right,” “front,” “back,” “rear,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” part can become a “lower” part simply by turning the object over. Nevertheless, it is still the same part and the object remains the same.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods, as known to those of ordinary skill in the art. When directly and explicitly distinguishing embodiments from discussed prior art, the embodiment numbers are not approximates unless the word “about” is recited. Whenever “substantially,” “approximately,” “about,” or similar language is explicitly used in combination with a specific value, variations up to and including ten percent (10%) of that value are intended, unless explicitly stated otherwise.

The term “product” means any machine, manufacture and/or composition of matter as contemplated by 35 U.S.C. § 101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise. Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

A reference to “another embodiment” in describing an embodiment does not imply that the referenced embodiment is mutually exclusive with another embodiment (e.g., an embodiment described before the referenced embodiment), unless expressly specified otherwise.

The indefinite articles “a” and “an,” as used herein in the specification and in the claims, unless clearly indicated to the contrary, should be understood to mean “at least one.” This rule applies even within the body of a claim where a first instance of an element utilizes “a” or “an” and a second or subsequent instance of the element necessarily utilizes (e.g., for purposes of proper grammar and required antecedent basis) the definite article “the” to refer to the element. The use of the definite article “the” does not limit the element to a single object merely because it is utilized to refer back to a previous mention of the element. The original reference to the element controls with respect to the plurality (or lack thereof) of the element.

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices which are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this patent application and the title of this patent application are for convenience only, and are not to be taken as limiting the disclosure in any way.

“Determining” something can be performed in a variety of manners and therefore the term “determining” (and like terms) includes calculating, computing, deriving, looking up (e.g., in a table, database or data structure), ascertaining and the like

The terms “including”, “comprising” and variations thereof mean “including but not limited to”, unless expressly specified otherwise. As used herein, “comprising” means “including,” and the singular forms “a” or “an” or “the” include plural references unless the context clearly dictates otherwise. The term “or” refers to a single element of stated alternative elements or a combination of two or more elements, unless the context clearly indicates otherwise

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicant intends to file additional applications to pursue patents for subject matter that has been disclosed and enabled but not claimed in the present application.

It will be understood that various modifications can be made to the embodiments of the present disclosure herein without departing from the scope thereof. Therefore, the above description should not be construed as limiting the disclosure, but merely as embodiments thereof. Those skilled in the art will envision other modifications within the scope of the invention as defined by the claims appended hereto.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used.

Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

Any of the features illustrated or described with respect to FIG. 1A, FIG. 1B, FIG. 1C, FIG. 1D, FIG. 1E, FIG. 1F, FIG. 2A, FIG. 2B, FIG. 2C, FIG. 2D, FIG. 2E, FIG. 2F, FIG. 2G, FIG. 2H, FIG. 3 FIG. 4A, and/or FIG. 4B can be combined with any other features illustrated or described with respect to FIG. 1A, FIG. 1B, FIG. 1C, FIG. 1D, FIG. 1E, FIG. 1F, FIG. 2A, FIG. 2B, FIG. 2C, FIG. 2D, FIG. 2E, FIG. 2F, FIG. 2G, FIG. 2H, FIG. 3 FIG. 4A, and/or FIG. 4B to provide systems, assemblies, modules, products, methods, articles of manufacture, and/or embodiments not otherwise illustrated or specifically described herein. Other combinations and variations are also possible according to one or more contemplated embodiments. All features described herein are independent of one another and, except where structurally impossible, can be used in combination with any other feature described herein.

While the term “vials” is utilized herein for convenience and ease of illustration, objects represented and/or described as “vials” may comprise various forms, configurations, and/or quantities of components. A BFS vial may comprise one or more BFS products that are formed and/or manufactured together or separately, for example, and/or may comprise one or more BFS modules, chambers, bottles, containers, and/or other fluid-retaining objects. The term “vials” does not convey any designation of shape or size. In some embodiments, a BFS assembly may comprise one or more vials. According to some embodiments a BFS assembly and/or a BFS vial may comprise one or more fluid chambers. In some embodiments, a plurality of BFS modules, components, vials, and/or chambers may be manufactured simultaneously from a single BFS mold. Each respective vial and/or chamber may be formed, for example, by different portions of a single BFS mold (e.g., at least two (2) cooperative halves thereof). In some embodiments, BFS modules, components, vials, and/or chambers may be joined and/or coupled during manufacturing (e.g., via unformed and/or fused connecting parison) and/or after manufacturing/filling.

What is claimed is:

1. A Blow-Fill-Seal (BFS) vial, comprising:
a fluid seal disposed at a first end of the BFS vial;
at least one external mounting feature formed near the first end of the BFS vial; and
a fluid reservoir disposed between the first end and a second end of the BFS vial, the fluid reservoir being filled with a combination of a gas and a liquid and wherein a liquid to air ratio is greater than one to two (1:2) and the BFS vial comprising a mold separation weld line disposed on a portion of the BFS vial other than the fluid reservoir.

2. The BFS vial of claim 1, wherein a wall thickness of the fluid reservoir is between four tenths (0.4-mm) of a millimeter and seven tenths of a millimeter (0.7-mm).

3. The BFS vial of claim 71, wherein the wall thickness of the fluid reservoir is fifty-five hundredths of a millimeter (0.55-mm).

4. The BFS vial of claim 1, wherein the fluid reservoir comprises a cross-sectional shape defining a low arch having a length to height ratio of approximately twelve to one (12:1).

5. The BFS vial of claim 1, wherein the fluid reservoir comprises a length between thirteen millimeters (13.0-mm) and fourteen and one half millimeters (14.5-mm).

6. The BFS vial of claim 1, wherein the fluid reservoir comprises a width between eleven and sixth tenths millimeters (11.6-mm) and twelve and twelve and eight tenths millimeters (12.8-mm).

7. The BFS vial of claim 1, wherein the BFS vial further comprises:
a cylindrical chamber portion in fluid communication with the fluid reservoir.

8. The BFS vial of claim 7, wherein the mold separation weld line is disposed radially across the cylindrical chamber portion.

9. The BFS vial of claim 1, wherein the BFS vial further comprises:
a label tab extending axially from the fluid reservoir.

10. The BFS vial of claim 9, wherein the label tab comprises an axial detent.

11. The BFS vial of claim 1, wherein the liquid to air ratio is one to five (1:5).

12. The BFS vial of claim 1, wherein liquid comprises a volume of six tenths of a milliliter (0.6-ml).

13. The BFS vial of claim 1, wherein liquid comprises a volume of one and one tenth milliliters (1.1-ml).

14. The BFS vial of claim 1, wherein the BFS vial comprises a height of seventy-six millimeters (76-mm).
